(19) United States
(12) Patent Application Publication
(10) Pub. No.: US 2007/0253109 A1
(43) Pub. Date: Nov. 1, 2007

(54) Recordable data storage cartridge having optically writable label surface

(76) Inventor: Eric Soeken, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/413,804

(22) Filed: Apr. 28, 2006

(51) Int. Cl. G11B 23/02; G11B 15/68

(52) U.S. Cl. 360/132; 720/729; 360/92

(57) ABSTRACT

A recordable data storage cartridge includes a housing and a recordable data storage medium. The recordable data storage medium is at least partially encased within the housing. The housing has an optically writable and optically readable surface.

### BACKGROUND

Computerized systems are commonly used to store large amounts of critical data, on hard disk drives and other types of storage devices. Such data may be critical in that if the data were lost, it would be at least nearly impossible, if not economically infeasible, to recover, or recoverable only with greatly expended cost and effort. However, like all types of electronic devices, hard disk drives and other types of storage devices can and occasionally do fail.

Therefore, data stored on hard disk drives and other types of storage devices is commonly backed up to other storage devices. One typical type of backup storage device is the tape backup storage device. A tape backup storage device backs up data to tape cartridges inserted into the device. Even the highest-capacity tape cartridge, however, does not store a sufficient amount of data to store all the data of a typical organization's computerized systems on a single cartridge. Data is thus typically backed up over a number of such tape cartridges. For small organizations, an administrator may manually insert and remove tape cartridges from a tape backup storage device during the backup process. However, for larger organizations and in other situations where a large amount of data is to be backed up, this manual process can become untenable.

Therefore, some types of tape backup storage devices are designed to allow the use of a number of cartridges to achieve data backup, without requiring manual insertion and removal of tape cartridges. Such tape backup storage devices are referred to in varying ways, such as stackers, autoloaders, and libraries. A given tape backup storage device may have a number of slots to store a corresponding number of tape cartridges. When data is to be backed up on a given cartridge, it is moved from a slot to a read/write mechanism, or drive, within the device.

For such multiple-cartridge tape backup storage devices to work properly, the individual tape cartridges usually have to be identifiable to the device in question. Typically, a bar code label is placed on each tape cartridge. However, bar code labels are prone to several potential problems. The labels can be placed on the tape cartridges in a crooked manner, preventing them from being read within the backup storage device. Additionally, the labels may not be secured properly to the tape cartridge, such that they may fall off within the backup storage device or become stuck within the device. Furthermore, placing the bar code labels on the tape cartridges is a time-consuming, and thus expensive, task. Bar code labels can themselves also be expensive to procure.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of a mass-media storage device, according to an embodiment of the invention.

FIGS. 2A, 2B, and 2C are diagrams of mass-media storage devices, according to varying embodiments of the invention.

FIGS. 3A, 3B, and 3C are a perspective view diagram, a cross-sectional top view diagram, and a back view diagram, respectively, of a cartridge, according to an embodiment of the invention.

FIG. 4 is a method of manufacture and use of the cartridge of FIGS. 3A, 3B, and 3C, according to an embodiment of the invention.

FIGS. 5A and 5B are a front view diagram and a side view diagram, respectively, of a portion of a mass-media storage device, according to an embodiment of the invention.

FIG. 6 is a method of use of the mass-media storage device of FIGS. 5A and 5B, according to an embodiment of the invention.

FIGS. 7A and 7B are side view diagrams of a portion of a mass-media storage device, according to varying embodiments of the invention.

FIG. 8 is a method of use of the mass-media storage device of FIG. 7A or FIG. 7B, according to an embodiment of the invention.

FIGS. 9A and 9B are side view diagrams of a portion of a mass-media storage device, according to an embodiment of the invention.

FIG. 10 is a method of use of the mass-media storage device of FIGS. 9A and 9B, according to an embodiment of the invention.

FIG. 11 is a side view diagram of a portion of a mass-media storage device, according to an embodiment of the invention.

FIG. 12 is a method of use of the mass-media storage device of FIG. 11, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Mass-Media Storage Device

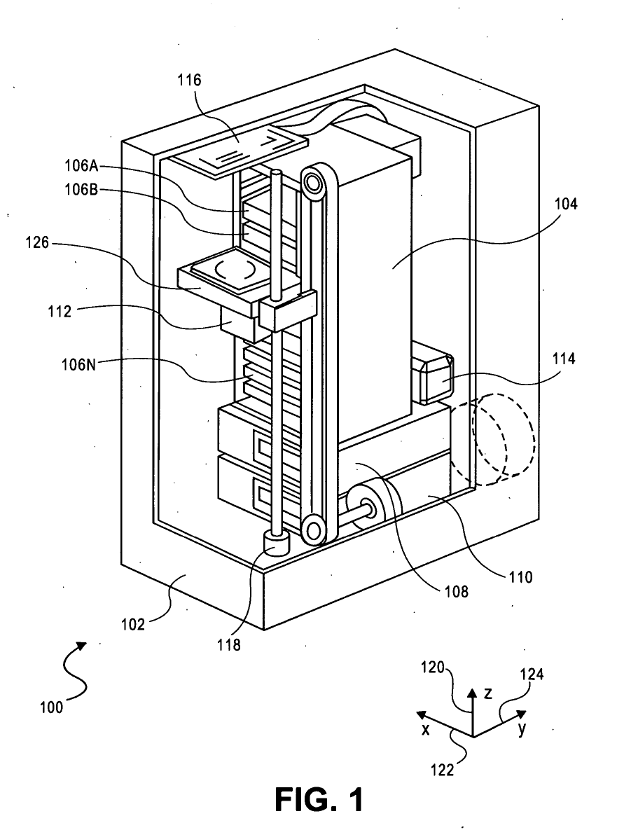

FIG. 1 shows a mass-media storage device 100, according to an embodiment of the invention. The mass-media storage device 100 is typically intended to back up data from another storage device, such as one or more hard disk drives. The storage device 100 includes a housing 102 that at least partially encases all the other components of the storage device 100. As depicted in FIG. 1, the storage device 100 includes a magazine rack 104, two read/write mechanisms 108 and 110, an optical labeling mechanism, robotic cartridge handling mechanism 126, a power supply 114, a controller 116, and a shaft 118. As can be appreciated by those of ordinary skill within the art, other embodiments of the storage device 100 may have other components, in addition to and/or in lieu of those depicted in the embodiment of FIG. 1. Three axes are also depicted in FIG. 1: a z-axis 120, an x-axis 122, and a y-axis 124, which will be employed in other figures as well.

The magazine rack 104 has a number of storage slots 106A, 106B, . . . , 106N, collectively referred to as the storage slots 106. Each of the storage slots 106 is receptive to a cartridge on which data is capable of being stored, or backed up. One particular type of cartridge is described later in the detailed description. In one embodiment, the cartridges inserted into the storage slots 106 cannot have data stored thereon or read therefrom while in the slots 106 themselves.

Rather, the read/write mechanisms 108 and 110 are employed to store data to and read data from the cartridges. While there are two read/write mechanisms 108 and 110 in the embodiment of FIG. 1, in other embodiments there may be as few as one such read/write mechanism or more than two such mechanisms. Therefore, description herein is made primarily to the read/write mechanism 108, as representative of the operation of both the read/write mechanisms 108 and 110.

A cartridge is removed from one of the storage slots 106, and inserted into a slot of the read/write mechanism 108 in order for the read/write mechanism 108 to write data to or read data from the cartridge. The read/write mechanism 108 may in one embodiment be considered a storage drive. The data written to a cartridge by the mechanism 108 is desirably that which is to be backed up to the cartridge. Similarly, the data read from a cartridge by the mechanism 108 is desirably that which is to be restored from the cartridge.

The robotic cartridge handling mechanism 126 is capable of moving up and down on the shaft 118 along the z-axis 120. Thus, the mechanism 126 is positionable opposite a desired one of the storage slots 106 to remove a cartridge from this storage slot, and then is positionable opposite the read/write mechanism 108 to insert the cartridge into the mechanism 108. When the read/write mechanism 108 is finished reading from or writing to the cartridge, the robotic cartridge handling mechanism 126 removes the cartridge from the mechanism 108 and returns it to the appropriate storage slot. The robotic cartridge handling mechanism 126 may in one embodiment be considered a picker.

The optical labeling mechanism 112 is depicted in the embodiment of FIG. 1 as being attached to the bottom of the robotic cartridge handling mechanism 126. The optical labeling mechanism 112 optically writes data, such as a label, to and/or optically reads the data or label from a surface of the housing of each cartridge, as is described in more detail later in the detailed description. It is noted that the optical labeling mechanism 112 does not write or read data that is to be backed up on the cartridges, but rather writes and reads data that is intended to uniquely identify the cartridges from one another.

That is, the cartridges disposed within the storage slots 106 of the storage device 100 are desirably uniquely identifiable at least as compared to one another, if not in relation to other cartridges not inserted within the storage device 100. The optical labeling mechanism 112 is thus able to optically write data, such as a label, to a surface of the housing of each cartridge, where this data or label at least substantially uniquely identifies the cartridge. When the storage device 100 is to determine the identity of a given cartridge in one of the storage slots 106, the optical labeling mechanism 112 can then optically read the previously optically written data or label in order to learn the identity of the cartridge.

Therefore, in one embodiment, the optical labeling mechanism 112 may replace a bar code reader that may otherwise be present within a mass-media storage device like the storage device 100 for cartridge-identification purposes. The optical labeling mechanism 112 is advantageous as compared to a bar code reader, because it is able to optically write data, such as a label like a bar code in one embodiment, to a surface of the housing of each cartridge. By comparison, a bar code reader is just able to read a bar code from a bar code label that has been previously affixed to the housing of each cartridge. By employing the optical labeling mechanism 112, the mass-media storage device 100 saves users from having to manually affix bar code labels to the cartridges, and prevents other problems associated with labels, as have been described in the background section.

Furthermore, the optical labeling mechanism 112 may optically write other data to a surface of the housing of each cartridge. For instance, information regarding when a given cartridge was first placed in service for backing up data, when a cartridge was last used, how much data is stored on a given cartridge, and so on, may be optically written on the surface of the housing of the cartridge. Because a bar code reader can only read bar codes, and cannot write data to cartridges inserted into a mass-media storage device, it is unable to write such additional information to the cartridge over the period within which the cartridge is used within the storage device.

Finally, the mass-media storage device 100 includes other components, such as the power supply 114 and the controller 116. The power supply 114, as can be appreciated by those of ordinary skill within the art, provides power to the various components of the storage device 100, and is typically plugged into an external power source, such as a wall outlet. The controller 116, as can also be appreciated by those of ordinary skill within the art, permits the storage device 100 to communicate with a computing device, or another type of device, to which it is communicatively connected, among other functionality. For instance, the controller 116 receives data to be backed up to the cartridges inserted into the device 100 from a computing device, and sends previously backed up data to be restored back to the computing device.

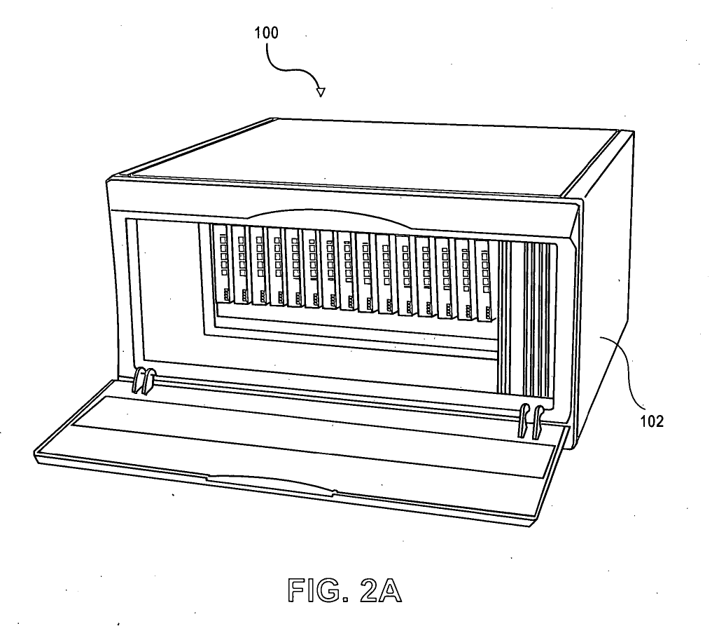

The mass-media storage device 100 may also be referred to as a stacker, an autoloader, or a library, among other terms. The mass-media storage device 100 may have other form factors besides that depicted in FIG. 1. For instance, FIGS. 2A, 2B, and 2C show other embodiments of the mass-media storage device 100, where only some of the components of the storage device 100 are particularly called out in these figures. The mass-media storage device 100 may have even other form factors, such as a carousel form factor, and so on, as can be appreciated by those of ordinary skill within the art.

In the next section of the detailed description, an exemplary cartridge that can be employed within the mass-media storage device 100 is described. Thereafter, particular embodiments of the optical labeling mechanism 112 of the storage device 100 are described. However, embodiments of the invention are not limited to any of these embodiments of the optical labeling mechanism 112, and the optical labeling mechanism 112 can be implemented in ways other than is described herein.

Cartridge

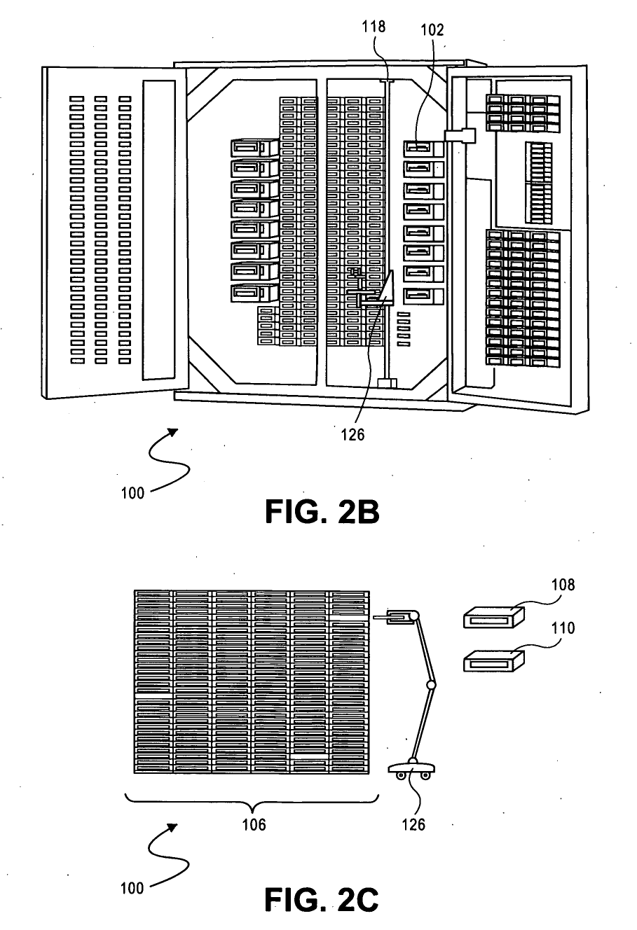

FIGS. 3A, 3B, and 3C show a cartridge 300 that can be employed in the mass-media storage device 100, according to an embodiment of the invention. FIG. 3A particularly shows a perspective view of the cartridge 300, FIG. 3B particularly shows a cross-sectional top view of the cartridge 300, and FIG. 3C particularly shows a back view of the cartridge 300. At least two of the x-axis 122, the y-axis 124, and the z-axis 120 are depicted in each of FIGS. 3A, 3B, and 3C as well, to indicate how the views of these figures correspond to one another as well as to FIG. 1.

The cartridge 300 includes a housing 302. The housing 302 may be fashioned from one or more different parts, such as a metal base plate and a plastic case in one embodiment. The housing 302 in one embodiment at least partially encases a supply reel 314, a take-up reel 316, and a recordable data storage medium 318. The recordable data storage medium 318 is specifically a magnetically recordable tape that is unwound from the supply reel 314 and winded on the take-up reel 316 during reading or writing, and then is wound back to the supply reel 314. As such, the cartridge 300 is specifically a tape cartridge.

The tape cartridge may have a particular form factor. Such tape cartridge form factors include those of a Travan® cartridge, a digital data storage (DDS) or digital audio tape (DAT) cartridge, and a digital linear tape (DLT) cartridge, among other types of cartridges. Furthermore, other embodiments of the invention may employ other types of cartridge, such as cartridges having housings at least partially encasing other types of magnetically recordable data storage media, as well as optically recordable data storage media, magneto-optical data storage media, and so on.

The cartridge 300 is depicted in the embodiment of FIGS. 3A, 3B, and 3C as including a protective cover 304 at a front end, or surface, thereof. The cover 304 is pivotable on two pins at the left and right sides of the cartridge 300, including the pin 308 specifically shown in FIG. 3A, so that it is able to swing up, as indicated by the arrow 306, to expose the recordable data storage medium 318. The y-axis 124 points in the opposite direction in FIG. 3A as compared to in FIG. 1.

Thus, the cartridge 300 is inserted into the read/write mechanism 108 of FIG. 1 such that the front end of the cartridge 300, at which the protective cover 304 is disposed, is inserted into the mechanism 108 first. Insertion of the cartridge 300 into the read/write mechanism 108 in this way causes the cover 304 to swing up, to expose the recordable data storage medium 318 to and for access by the mechanism 108. Therefore, the cover 304 protects the recordable data storage medium 318, is normally closed upon removal of the cartridge 300 from the mass-media storage device 100 of FIG. 1, and is opened upon insertion of the cartridge 300 into the read/write mechanism 108 of the device 100.

The back surface 310 of the cartridge 300 has a coating 312 applied thereto that permits the back surface 310 to be optically writable and optically readable. The coating 312 is more generally referred to as a layer. The thickness of the coating 312 is exaggerated in FIGS. 3A, 3B, and 3C for illustrative clarity. In actuality, the coating 312 may be as thin as microns or millimeters in thickness. Furthermore, in another embodiment, the back surface 310 may be rendered optically writable and optically readable by a manner other than the coating 312.

The coating 312 may in one embodiment be that which is described in the patent application entitled “Integrated CD/DVD Recording and Label” [attorney docket 10011728-1], filed on Oct. 11, 2001, and assigned Ser. No. 09/976,877. In the Ser. No. 09/976,877 patent application, a manner by which a coating can be applied to the label side of an optical disc is described, to render the label side of the optical disc optically writable and readable. Thus, the same technique may be used herein to render the surface 310 of the cartridge 300 optically writable and readable.

As particularly depicted in FIGS. 3B and 3C, in one embodiment the coating 312 may extend completely over the back surface 310 to render the entire surface 310 optically writable and readable. However, in another embodiment, the coating 312 may be applied to just a portion of the surface 310, such that just this portion of the surface 310 is optically writable and readable. It is noted that other surfaces of the cartridge 300, in addition to and/or in lieu of the surface 310, may also be optically writable and optically readable.

Prior to optical writing of data, such as a label or a marking, on the coating 312, the back surface 310 may be blank and thus a blank surface. Such a blank surface is therefore, by virtue of the coating 312 in one embodiment, adapted to being optically written to within the mass-media storage device 100 of FIG. 1. The storage device 100 may then be used to optically write data, such as a label or a marking, on the back surface 310 of the cartridge 300.

In another embodiment, the back surface 310 may have data, such as a label or a marking, optically written on its coating 312, for instance, by a device other than the storage device 100. For instance, prior to acquisition by an end user who uses the storage device 100 for backing up data, the end user may specify that a distributor, consultant, manufacturer, or another party optically write data in a specified manner, such as by optically writing data that uniquely identifies the cartridge 300, like in the form of a bar code. In such instances, the end user may use the cartridge 300 within a mass-media storage device, other than the storage device 100, that employs a conventional bar code reader, instead of the optical labeling mechanism 112. That is, in this embodiment of the invention, the cartridge 300 is optically written to for usage in a conventional mass-media storage device, instead of the inventive mass-media storage device 100 of FIG. 1.

That the back surface 310 of the cartridge 300 is optically writable means that a laser or another type of optical beam can be employed to optically write data, such as a marking or a label, to the surface 310. For instance, the coating 312 may be a phase-change material, which changes phase and thus reflectivity at a given location when that location is heated by the laser or other type of optical beam. The optically written data can further be read from the surface 310 of the cartridge 300 by using a laser or other type of optical beam, where the laser or other beam is reflected differently and thus detected differently depending on whether the coating 312 at a given location on the surface 310 has had its phase changed. The optically written data can thus be optically read in at least a substantially similar fashion as to how the data was written, insofar as the same laser or other type of optical beam is used by the optical labeling mechanism 112 of FIG. 1, for instance, to both optically write to and read from the surface 310.

The back surface 310 of the cartridge 300, with the coating 312, being optically writable differentiates it from a bar code that may be conventionally written on a surface of a cartridge or on a label affixed to such a surface. A label affixed to the surface of a cartridge is not conventionally optically writable, for instance. Rather, a bar code may be written to such a label via conventional printing techniques, such as ink-writing processes like inkjet printing and toner-writing processes like laser printing.

While laser printing in particular does involve employment of a laser or another type of optical beam, the bar code or other thing being written to the label is not actually optically written to the label, in the sense that an optical beam by itself is not employed to change the reflectivity of the label at various locations thereof. Rather, the laser is simply used to define where toner is to be affixed to the label, where the toner itself has a reflectivity different than that of the label. Thus, laser printing is to be considered a toner-writing process, and not a completely optical-writing process as is used by embodiments of the invention.

Furthermore, where a bar code is directly written to the surface of a cartridge as is conventionally accomplished, typically what occurs is that an inkjet printing process is used to deposit ink on this surface in the form of a bar code. While such a bar code may be optically readable, it is not optically written to this surface of the cartridge, and the surface is itself not optically writable in such situations. These and other aspects of embodiments of the invention distinguish them from conventional bar code labeling processes found within the prior art.

When the cartridge 300 is stored in one the of storage slots 106 of FIG. 1, the back surface 310 of the cartridge 300 is opposite the robotic cartridge handling mechanism 126, and thus opposite the optical labeling mechanism 112. Therefore, in one embodiment, the optical labeling mechanism 112 is able to optically write to and optically read from the surface 310 of the cartridge 300 while the cartridge 300 is stored in one of the storage slots 106. This and other embodiments of the invention are described in detail in subsequent sections of the detailed description.

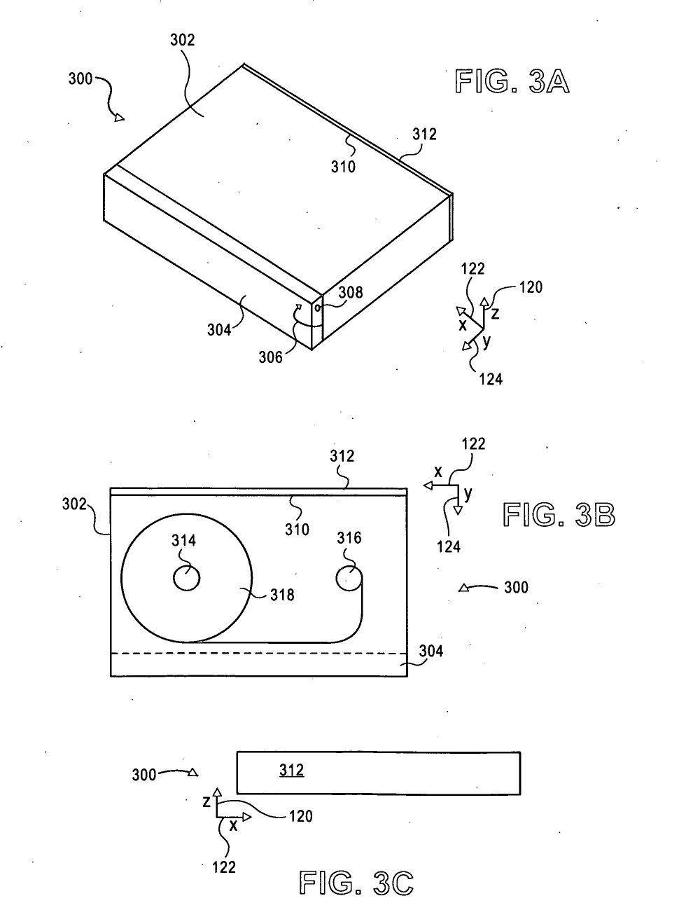

FIG. 4 shows a method 400 of the manufacture and use of the data storage cartridge 300 in relation to the mass-media storage device 100 of FIG. 1, according to an embodiment of the invention. The data cartridge 300 is provided (402), where the cartridge 300 has the recordable data storage medium 318. A surface of the cartridge 300, such as the back surface 310 of the housing 302 of the cartridge 300, is at least partially coated with an optically readable and optically writable layer, such as the coating 312 (404). The coating process may be a silk-screening process, for instance.

Prior to delivery of the cartridge 300 to an end user, one or more markings, such as data or a label like a bar code, may in one embodiment be optically written on the coating 312 (406). These markings may at least substantially uniquely identify the cartridge 300, compared to other cartridges, such as other cartridges that may be used with the mass-media storage device 100. The markings may be specified by the end user for whom the cartridge 300 is intended. The markings may be a bar code adapted to being read using a conventional bar code reader of a mass-media storage device, as has been described. Furthermore, the markings may be optically readable in at least a substantially similar fashion as to how the markings are optically written, as has also been described. The part 406 of the method 400 is not performed by the mass-media storage device 100, but rather by another device, where the storage device 100 is that of the end user.

The data cartridge 300 is then ultimately sold to the end user (408), who inserts the cartridge into the mass-media storage device 100 (410), such that the storage device 100 is receptive to or otherwise receives the cartridge 300. The mass-media storage device 100 may optically write other markings, such as other data or another label like a bar code, and/or may optically read these markings or the markings written in the part 406 of the method 400 (412). The mass-media storage device 100 may further write data to and/or read data from the recordable data storage medium 318 of the cartridge 300 (414), which may be accomplished in non-optical manner, such as in a magnetic manner, as opposed to as in an optical manner as is accomplished in relation to the coating 312 of the cartridge 300.

### First Specific Embodiment of Optical Labeling Mechanism

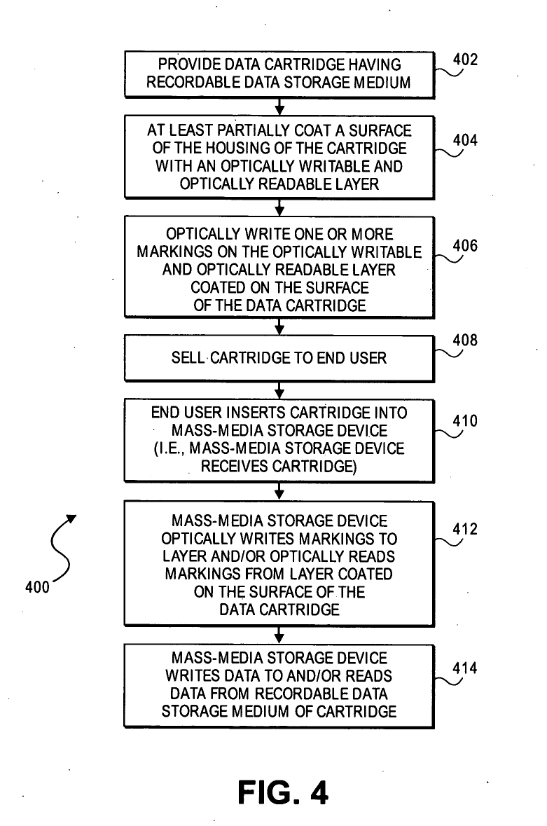

FIGS. 5A and 5B show a portion of the mass-media storage device 100 to illustrate a particular embodiment of the optical labeling mechanism 112. FIG. 5A particularly shows a front view of the optical labeling mechanism 112, in which the x-axis 122 and the z-axis 120 are depicted as is shown in FIG. 5A, and the y-axis 124 is perpendicular to and coming out of the plane of the figure. FIG. 5B particularly shows a side view of the optical mechanism 112, in which the y-axis 124 and the z-axis 120 are depicted as is shown in FIG. 5B.

The optical labeling mechanism 112 is attached to the underside of the robotic cartridge handling mechanism 126, but may alternatively be attached to the topside of the handling mechanism 126. As before, the handling mechanism 126 is to move the cartridge 300 from one of the slots 106, such as the slot 106C particularly depicted in FIG. 5B, into a slot of the read/write mechanism 108 for writing data to and/or reading data from the recordable data storage medium 318 of the cartridge 300. By comparison, the optical labeling mechanism 112 is to optically write to and/or optically read from the surface 310 of the cartridge 300, which has the coating 312. The front of the cartridge 300, including the protective cover 304, is positioned to the back of the slot 106C, such that the surface 310 is exposed within the slot 106C, as particularly depicted in FIG. 5B.

The optical labeling mechanism 112 includes an optical beam generator 502, such as a laser generator. The optical beam generator 502 may also be referred to as an optical read/write component, or it may be a part of such a component that also includes other parts besides the generator 502. As can be appreciated by those of ordinary skill within the art, the labeling mechanism 112 can and typically will include other components, in addition to and the optical beam generator 502. The optical beam generator 502 is able to move in four directions along the plane defined by the x-axis 122 and the z-axis 120, as indicated by the arrows 504A, 504B, 504C, and 504D, collectively referred to as the arrows 504. Thus, in the embodiment of FIGS. 5A and 5B, the handling mechanism 126 is moved so that the optical labeling mechanism 112 is positioned opposite the cartridge 300. The optical beam generator 502 then moves in the four directions indicated by the arrows 504, and the optical beam turned on, as desired to achieve the optical writing of a particular image, label, data, or other marking on the surface 310 of the cartridge 300, or to read previously written markings from the surface 310.

Therefore, in the embodiment of FIGS. 5A and 5B, the cartridge 300 remains in the storage slot 106C while the optical labeling mechanism 112 optically writes to or optically reads from the surface 310 of the cartridge 300. The robotic cartridge handling mechanism 126 remains stationary while the optical beam generator 502 moves in the four directions indicated by the arrows 504. However, in another embodiment, the optical beam generator 502 itself may be stationary relative to the optical labeling mechanism 112, such that the mechanism 126 and/or the mechanism 112 move in order for the mechanism 112 to optically write to or optically read from the surface 310 of the data cartridge 300.

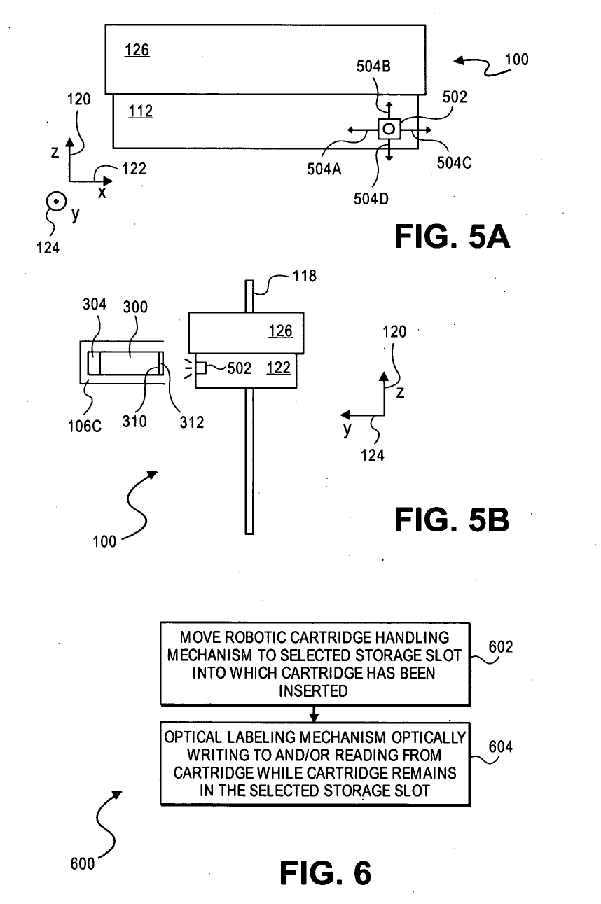

FIG. 6 shows a method 600 for using the mass-media storage device 100 of FIGS. 5A and 5B, according to an embodiment of the invention. First, the robotic cartridge handling mechanism 126 is moved to a selected storage slot of the storage slots 106, where the cartridge 300 has been inserted into this selected slot (602). The robotic cartridge handling mechanism 126 is specifically moved to this slot so that the optical labeling mechanism 112, which is attached to the mechanism 126, is positioned opposite the cartridge 300. The optical labeling mechanism 112 then optically writes to and/or optically reads from the cartridge 300 (604), while the cartridge 300 remains in the selected storage slot.

It is noted that the embodiment of the optical labeling mechanism 112 that has been described in this section of the detailed description may be considered a separate, add-on component to an otherwise already-existing mass-media storage device to provide the storage device 100 with cartridge optical writing and reading capability. In such instance, the mechanism 112 implicitly includes a housing that is adapted to being installed within the mass-media storage device, as well as an optical read/write component attached to the housing. The housing is more particularly adapted to being attached to the robotic cartridge handling mechanism 126 as has been described.

### Second Specific Embodiments of Optical Labeling Mechanism

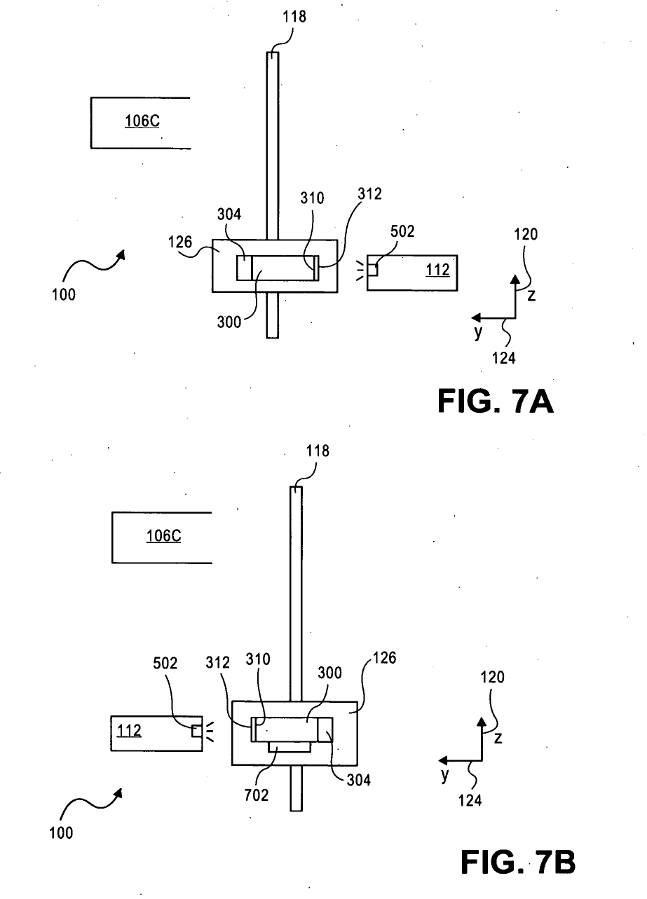

FIGS. 7A and 7B show a portion of the mass-media storage device 100 to illustrate two additional particular embodiments of the optical labeling mechanism 112. Both FIGS. 7A and 7B show a side view of the optical mechanism 112, in which the y-axis 124 and the z-axis 120 are depicted as is shown. The optical labeling mechanism 112 is not attached to the robotic cartridge handling mechanism 126 in the embodiments of FIGS. 7A and 7B, unlike the embodiment of FIGS. 5A and 5B.

The robotic cartridge handling mechanism 126 removes the cartridge 300 from the storage slot 106C, and moves the cartridge 300 to the optical labeling mechanism 112, such that the surface 310 of the cartridge 300 is incident to the optical labeling mechanism 112. The optical beam generator 502 can move and optically read from or write to the surface 310 while the cartridge 300 remains in the handling mechanism 126, and while the handling mechanism 126 itself remains stationary. In another embodiment, the optical beam generator 502 does not move, and the handling mechanism 126 moves along the z-axis 120 and the x-axis 124 (perpendicular to the plane of FIGS. 7A and 7B) so that the generator 502 is incident to desired locations on the surface 310.

In FIG. 7A particularly, the storage slot 106C is located to and faces one side of the robotic cartridge handling mechanism 126, and the optical labeling mechanism 112 is located to and faces the other, opposite side of the handling mechanism 126. As has been described, the cartridge 300 is stored within the slot 106C so that the protective cover 304 is located at the closed end of the slot 106C, and so that the surface 310, with the coating 312, is located at the open end of the slot 106C. Therefore, in the embodiment of FIG. 7A, the handling mechanism 126 removes the cartridge 300 from the slot 106C, and just has to move along the z-axis 120 to where the optical labeling mechanism 112 is located for the surface 310 of the cartridge 300 to be incident to the mechanism 112.

By comparison, in FIG. 7B particularly, the storage slot 106C and the optical labeling mechanism 112 are both located to and face the same side of the robotic cartridge handling mechanism 126. However, because the cartridge 300 is stored within the slot 106C so that the protective cover 304 is located at the closed end of the slot 106C and so that the surface 310, with the coating 312, is located at the open end 106C, the handling mechanism 126 rotates the cartridge 300 while the cartridge is in the mechanism 126. Such rotation of the cartridge 300 is performed so that the surface 310 of the cartridge 300 is incident to the optical labeling mechanism 112. The handling mechanism 126 may include a rotation mechanism 702, such as one or more servo or other types of motors, to achieve rotation of the cartridge 300 therewithin.

Other variations to the embodiments of FIGS. 7A and 7B are also possible. For instance, the optical labeling mechanism 112 may be attached to the side of the robotic cartridge handling mechanism 126 opposite the side of the handling mechanism 126 that the storage slot 106C faces. Alternatively, the optical labeling mechanism 112 may be attached inside the handling mechanism 126, at the side thereof opposite the side that the storage slot 106C faces. These embodiments are similar to the embodiment of FIG. 7A, except that the labeling mechanism 112 is attached to and/or inside the handling mechanism 126, instead of being unattached as is shown in FIG. 7A. Thus, the handling mechanism 126 removes the cartridge 300 from the slot 106C, and the labeling mechanism 112 is able to optically write to and read from the cartridge 300. That is, the handling mechanism 126 in these embodiments does not have to move along the z-axis 120 to move the cartridge 300 incident to the labeling mechanism 112, since the labeling mechanism is already attached to and/or inside the handling mechanism 126.

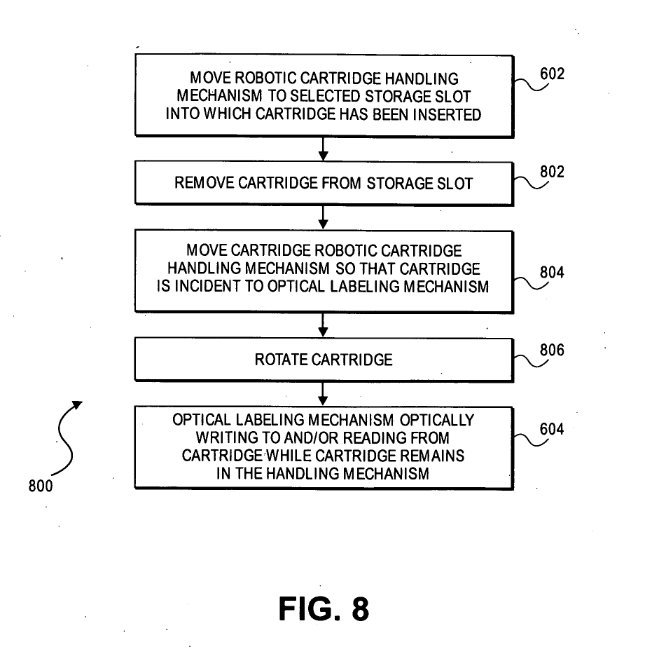

FIG. 8 shows a method 800 for using the mass-media storage device 100 of FIG. 7A or FIG. 7B, according to an embodiment of the invention. First, the robotic cartridge handling mechanism 126 is moved to a selected storage slot of the storage slots 106, where the cartridge 300 has been inserted into this selected slot (602). The handling mechanism 126 removes the cartridge 300 from this slot (802). The handling mechanism 126 is then moved so that the cartridge is incident to the optical labeling mechanism 112 (804), where the optical labeling mechanism 112 is not attached to the handling mechanism 126, as described in the previous paragraph. Furthermore, in the embodiment of FIG. 7B specifically, the cartridge 300 is also rotated within the handling mechanism 126 (806). Thus, the labeling mechanism 112 is able to optically write to and/or optically read from the cartridge 300 (604), while the cartridge 300 remains in the handling mechanism 126.

It is noted that the embodiments of the optical labeling mechanism 112 that have been described in this section of the detailed description may be considered a separate, add-on component to an otherwise already-existing mass-media storage device to provide the storage device 100 with cartridge optical writing and reading capability. In such instance, the mechanism 112 implicitly includes a housing that is adapted to being installed within the mass-media storage device, as well as an optical read/write component attached to the housing. The housing is more particularly adapted to being attached to the robotic cartridge handling mechanism 126 as has been described, or installed within the storage device such that it remains unattached to the handling mechanism 126 as has also been described.

### Third Specific Embodiment of Optical Labeling Mechanism

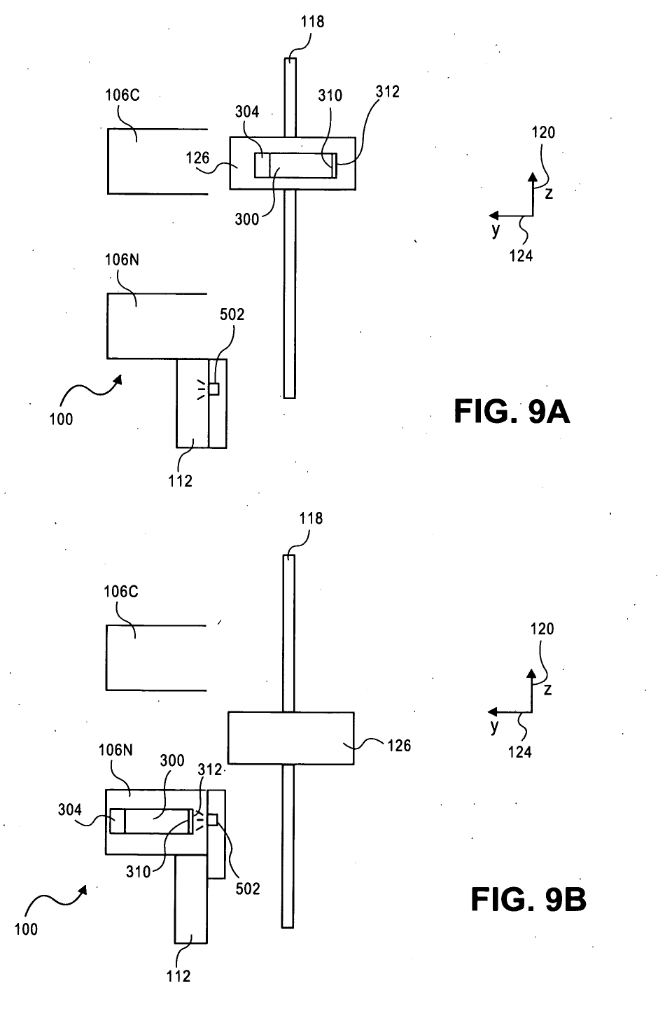

FIGS. 9A and 9B show a portion of the mass-media storage device 100 to illustrate another particular embodiment of the optical labeling mechanism 112.

FIGS. 9A and 9B both particularly show side views of the optical mechanism 112, in which the y-axis 124 and the z-axis 120 are depicted as is shown. In FIG. 9A, the robotic cartridge handling mechanism 126 has moved to the storage slot 106C along the shaft 118, and has removed therefrom the cartridge 300. Furthermore, the slot 106N is open in FIG. 9A, and is unblocked by the optical labeling mechanism 112.

The robotic cartridge handling mechanism 126 moves to the storage slot 106N along the shaft 118, and inserts the cartridge 300 into the storage slot 106N. The handling mechanism 126 then moves away from the storage slot 106N along the shaft 118. Thereafter, in FIG. 9B, a portion of the optical labeling mechanism 112 is moved so that it blocks the slot 106N. More particularly, the optical beam generator 502 of the mechanism 112 is incident to the surface 310 of the cartridge 300, having the coating 312. The protective covering 304 remains at the closed end of the slot 106N.

Thus, the embodiment of FIGS. 9A and 9B sacrifices one of the storage slots 106, such as the slot 106N, so that the cartridge 300 is moved into that slot when optical reading and/or optical writing of the surface 310 of the cartridge 300 is to be performed. The optical labeling mechanism 112 has a portion that is attached to the underside of the storage slot 106N, or in a slot immediately below the storage slot 106N, although in another embodiment this portion may be attached to the topside of the slot 106N, or in a slot immediately above the storage slot 106N. The optical labeling mechanism 112 also has another portion that moves over the opening of the slot 106N, so that the optical beam generator 502 is incident to the surface 310 of the cartridge 300, for optical reading and writing thereof. However, in one embodiment, the storage slot 106N may itself be considered a slot of the optical labeling mechanism 112. That is, use of the slot 106N for cartridge optical writing and reading purposes in this embodiment can render the slot 106N as part of the labeling mechanism 112 itself.

In the embodiment of FIGS. 9A and 9B, the cartridge 300 thus enters and then exits the robotic cartridge handling mechanism 126 before it is optically read or written. More specifically, the cartridge 300 is inserted into one of the storage slots 106 dedicated for optical reading and writing purposes, and to which the optical labeling mechanism 112 has been attached. The optical beam generator 502 is considered a movable component of the labeling mechanism 112, because it is part of the portion of the mechanism 112 that moves over slot 106N after the cartridge 300 has been inserted into the slot 106N and the handling mechanism 126 has moved away from the slot 106N.

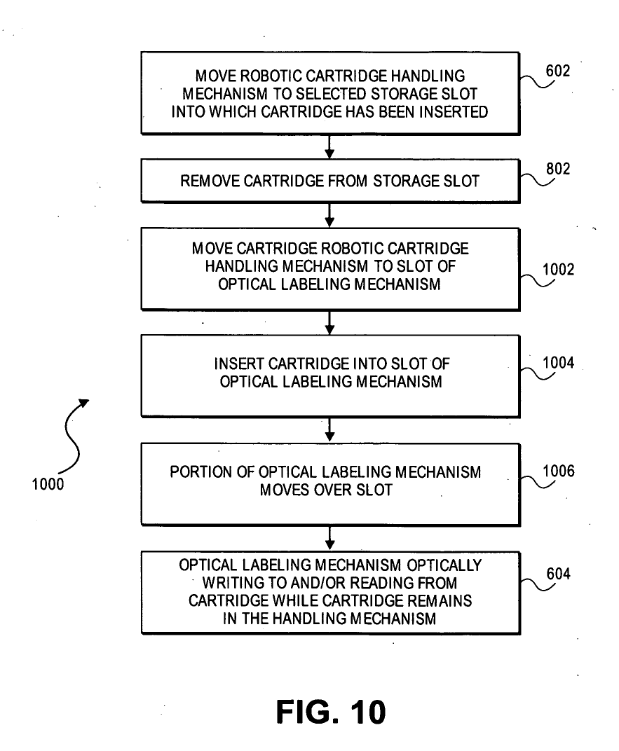

FIG. 10 shows a method 1000 for using the mass-media storage device 100 of FIGS. 9A and 9B, according to an embodiment of the invention. First, the robotic cartridge handling mechanism 126 is moved to a selected storage slot of the storage slots 106, where the cartridge 300 has been inserted into this selected slot (602). The handling mechanism 126 removes the cartridge 300 from this slot (802). The handling mechanism 126 is then moved to a slot of the optical labeling mechanism 112 (1002), and the cartridge is inserted into this storage slot (1004). The handling mechanism 126 may then be moved away from the slot. In any case, a portion of the optical labeling mechanism 112 moves over the storage slot (1006). Thus, the labeling mechanism 112 is able to optically write to and/or optically read from the cartridge 300 (604), while the cartridge 300 remains in this slot.

It is noted that the embodiment of the optical labeling mechanism 112 that has been described in this section of the detailed description may be considered a separate, add-on component to an otherwise already-existing mass-media storage device to provide the storage device 100 with cartridge optical writing and reading capability. In such instance, the mechanism 112 implicitly includes a housing that is adapted to being installed within the mass-media storage device. For instance, the housing may be inserted into a storage slot above or below the slot that becomes part of the mechanism 112 itself, as well as an optical read/write component attached to the housing. Stated another way, in relation to FIGS. 9A and 9B, the housing may be inserted into a storage slot above or below the storage slot 106N that ultimately becomes part of the mechanism 112 itself. For example, there may be a storage slot above the storage slot 106N, into which the housing is insertable for easy installation of the optical labeling mechanism 112 within an already-existing mass-media storage device.

### Fourth Specific Embodiment of Optical Labeling Mechanism

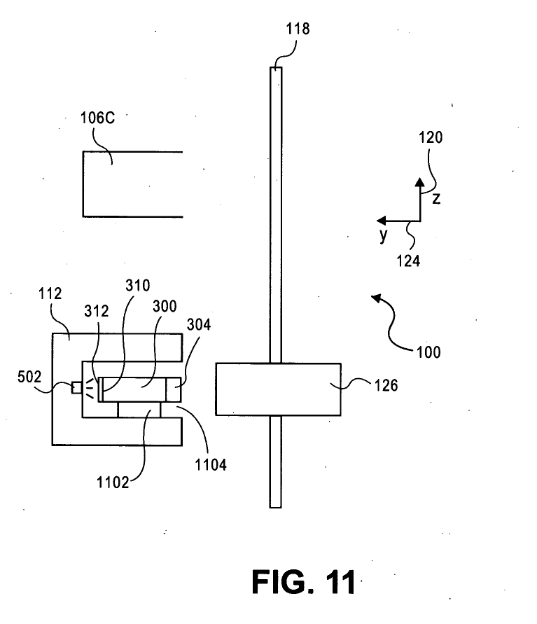

FIG. 11 shows a portion of the mass-media storage device 100 to illustrate another particular embodiment of the optical labeling mechanism 112. FIG. 11 particularly shows a side view of the optical mechanism 112, in which the y-axis 124 and the z-axis 120 are depicted as is shown. The robotic cartridge handling mechanism 126 moves to the storage slot 106C, removes the cartridge 300 therefrom, moves along the shaft 118 to a slot 1104 of the optical labeling mechanism 112, and inserts the cartridge 300 into the slot 1104 of the labeling mechanism 112.

Once inside the optical labeling mechanism 112, the cartridge 300 is rotated by a rotation mechanism 1102 of the labeling mechanism 112. Such rotation is performed so that back surface 310 of the cartridge 300, having the coating 312, is incident to the optical beam generator 502 of the labeling mechanism 112. That is, when the cartridge 300 is initially inserted into the slot 1104 of the labeling mechanism 112 by the robotic cartridge handling mechanism 126, the protective cover 304 of the cartridge 300 is incident to the optical beam generator 502. Therefore, rotation is accomplished so that the optical beam generator 502, and thus the labeling mechanism 112 itself, is able to optically write to and read from the surface of the cartridge 300. The rotation mechanism 1102 may be one or more servo or other types of motors.

Thus, the optical labeling mechanism 112 in the embodiment of FIG. 11 may be considered a special type of drive that is receptive to the cartridge 300, no different than the read/write mechanism 108 is a drive. The cartridge 300 is inserted the same way into the labeling mechanism 112 as it is into the read/write mechanism 108, with its protective cover 304 first. However, whereas the read/write mechanism 108 reads data from and writes data to the recordable data storage medium 318 of the cartridge 300, the optical labeling mechanism 112 optically reads and writes the surface 310 of the cartridge 300, with the coating 312. The read/write mechanism 108 also is unlikely to have to rotate the cartridge 300 to perform its reading and writing, whereas the optical labeling mechanism 112 includes the rotation mechanism 1102 to rotate the cartridge 300 so that the surface 310 is incident to the optical beam generator 502.

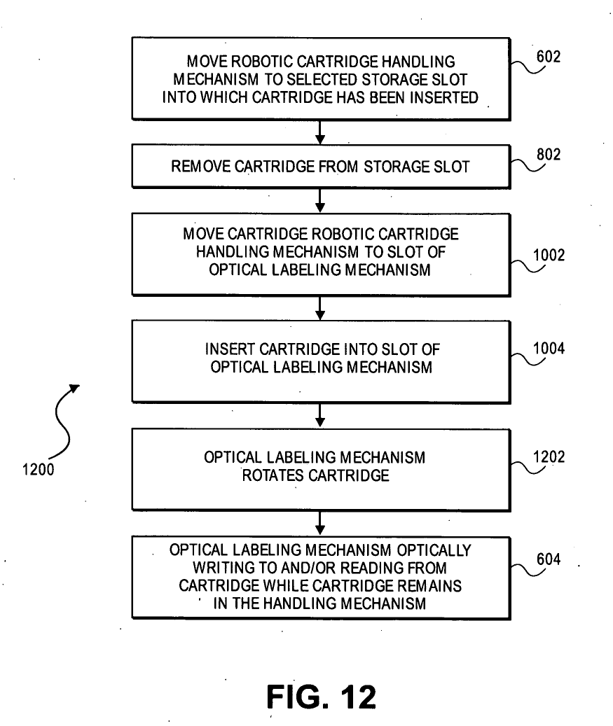

FIG. 12 shows a method 1200 for using the mass-media storage device 100 of FIG. 11, according to an embodiment of the invention. First, the robotic cartridge handling mechanism 126 is moved to a selected storage slot of the storage slots 106, where the cartridge 300 has been inserted into this selected slot (602). The handling mechanism 126 removes the cartridge 300 from this slot (802). The handling mechanism 126 is then moved to a slot of the optical labeling mechanism 112 (1002), and the cartridge is inserted into this storage slot (1004). The optical labeling mechanism 112 rotates the cartridge 300 while the cartridge 300 is within the labeling mechanism 112 (1202). Thus, the labeling mechanism 112 is able to optically write to and/or optically read from the cartridge 300 (604), while the cartridge 300 remains in this slot and thus in the optical labeling mechanism 112 itself.

It is noted that the embodiment of the optical labeling mechanism 112 that has been described in this section of the detailed description may be considered a separate, add-on component to an otherwise already-existing mass-media storage device to provide the storage device 100 with cartridge optical writing and reading capability. In such instance, the mechanism 112 implicitly includes a housing that is adapted to being installed within the mass-media storage device. The entirety of the mechanism 112 may be installed within such a mass-media storage device as another drive, in addition to and/or in lieu of an existing drive already within the device. For instance, the labeling mechanism 112 may in one embodiment replace the read/write mechanism 110 of FIG. 1.

### CONCLUSION

It is noted, therefore, that although specific embodiments have been illustrated and described herein, it will be appreciated by those of ordinary skill in the art that any arrangement calculated to achieve the same purpose may be substituted for the specific embodiments shown. This application is intended to cover any adaptations or variations of the disclosed embodiments of the present invention. For instance, while embodiments of the invention have been substantially described in relation to a cartridge housing a tape recordable data storage medium, other embodiments of the invention may be employed in relation to cartridges housing other types of recordable data storage media.

As another example, particular embodiments of the optical labeling mechanism of the mass-media storage device have been shown and described. However, other embodiments of the invention can employ other types of optical labeling mechanisms in configurations other than those that have been shown and described. That is, embodiments of the invention are amenable to different variations of the optical labeling mechanisms that have been shown and described, as well as to other types of optical labeling mechanisms that achieve the same optical cartridge reading and writing purpose. It is thus manifestly intended that this invention be limited only by the claims and equivalents thereof.

I claim:

1. A recordable data storage cartridge comprising:
a housing;
a recordable data storage medium at least partially encased within the housing; and,
an optically writable and optically readable surface of the housing.

2. The recordable data storage cartridge of claim 1, wherein the housing has a front surface and a back surface, the recordable data storage medium accessible via the front surface, the optically writable and optically readable surface being at least a portion of the back surface.

3. The recordable data storage cartridge of claim 1, wherein the optically writable and optically readable surface is a blank surface adapted to being optically written to within a mass-media storage device.

4. The recordable data storage cartridge of claim 1, wherein the optically writable and optically readable surface has optically written thereon one or more markings at least substantially uniquely identifying the cartridge.

5. The recordable data storage cartridge of claim 1, wherein the optically writable and optically readable surface has optically written thereon a bar code at least substantially uniquely identifying the cartridge.

6. The recordable data storage cartridge of claim 1, wherein the optically writable and optically readable surface has optically written thereon a bar code adapted to being read using a bar code reader of a mass-media storage device.

7. The recordable data storage cartridge of claim 1, wherein the optically writable and optically readable surface has optically written thereon one or more markings optically readable in at least a substantially similar fashion as to how the markings are optically written thereon.

8. The recordable data storage cartridge of claim 1, wherein the optically writable and optically readable surface has optically written thereon one or more markings as specified by an end user.

9. The recordable data storage cartridge of claim 1, further comprising a cover situated on a front side of the housing and protecting the recordable data storage medium from exposure, such that the cover is normally closed upon removal of the cartridge from a mass-media storage device and is opened upon insertion of the cartridge into a component of the mass-media storage device.

10. The recordable data storage cartridge of claim 1, wherein the recordable data storage medium comprises a magnetically recordable data storage medium.

11. The recordable data storage cartridge of claim 1, wherein the recordable data storage medium comprises:
a plurality of tape reels; and,
a tape wound on one of the tape reels and windable on other of the tape reels.

12. A recordable data storage cartridge comprising:
a housing;
a recordable data storage medium at least partially encased within the housing; and,
optically writable and optically readable means separate from the recordable data storage medium.

13. The recordable data storage cartridge of claim 12, wherein the housing has a front surface and a back surface, the recordable data storage medium accessible via the front surface, the optically writable and optically readable means being situated at the back surface.

14. The recordable data storage cartridge of claim 12, wherein the optically writable and optically readable means is blank.

15. The recordable data storage cartridge of claim 12, wherein the optically writable and optically readable means has optically written thereon one or more markings at least substantially uniquely identifying the cartridge.

16. The recordable data storage cartridge of claim 12, wherein the optically writable and optically readable means has optically written thereon a bar code at least substantially uniquely identifying the cartridge and adapted to being read using a bar code reader of a mass-media storage device.

17. The recordable data storage cartridge of claim 12, wherein the optically writable and optically readable means has optically written thereon one or more markings optically readable in at least a substantially similar fashion as to how the markings are optically written thereon.

18. The recordable data storage cartridge of claim 12, wherein the optically writable and optically readable means has optically written thereon one or more markings as specified by an end user.

19. The recordable data storage cartridge of claim 12, wherein the recordable data storage medium comprises a magnetically recordable data tape storage medium.

20. A method comprising:
providing a recordable data storage cartridge having a housing at least partially encasing a recordable data storage medium; and,
at least partially coating a surface of the housing of the cartridge with an optically writable and optically readable layer.

21. The method of claim 20, wherein the housing has a front surface and a back surface, the recordable data storage medium accessible via the front surface, the optically writable and optically readable layer coating at least a portion of the back surface.

22. The method of claim 20, further comprising optically writing one or more markings on the optically writable and optically readable layer coated on the surface of the housing, using a device other than a mass-media storage device in which the cartridge is to be used.

23. The method of claim 22, wherein the markings are one or more of:
at least substantially uniquely identify the cartridge;
a bar code adapted to being read using a bar code reader of the mass-media storage device;
optically readable in at least a substantially similar fashion as to how the markings are optically written; and,
specified by an end user.

24. The method of claim 22, further comprising selling the cartridge to an end user.

25. The method of claim 24, further comprising:
inserting the cartridge by the end user into the mass-media storage device; and,
optically reading the markings by the mass-media storage device.

26. The method of claim 20, further comprising selling the cartridge to an end user.

27. The method of claim 26, further comprising:
inserting the cartridge by the end user into a mass-media storage device; and,
optically writing one or more markings by the mass-media storage device on the optically writable and optically readable layer coated on the surface of the housing, by the mass-media storage device.

28. A method comprising:
receiving insertion of a recordable data storage cartridge having a surface of a housing that at least a portion of which is optically writable and optically readable by a mass-media storage device; and,
optically writing to and/or optically reading from the optically writable and optically readable portion of the surface, by the mass-media storage device.

29. The method of claim 28, further comprising the mass-media storage device writing data to and/or reading data from a recordable data storage medium of the cartridge.

30. The method of claim 29, wherein the data is written to and/or read from the recordable data storage medium in a non-optical manner.
